(19) United States
(12) Patent Application Publication
(10) Pub. No.: US 2006/0085590 A1
(43) Pub. Date: Apr. 20, 2006

(54) Data storage and matching employing words wider than width of content addressable memory

(75) Inventors: Andrew Davy, Harpenden (GB); Keith Robinson, Aylesbury (GB); Jerome Nolan, Dublin (IE); Eoghan Stack, Ballyvolane (IE)

Correspondence Address: JACKSON & CO., LLP, 6114 LA SALLE AVENUE, SUITE 507, OAKLAND, CA, 94611-2802, US

(73) Assignee: 3Com Corporation

(21) Appl. No.: 11/014,100

(22) Filed: Dec. 15, 2004

(30) Foreign Application Priority Data
Oct. 14, 2004 (GB) 0422777.3

(51) Int. Cl. G06F 12/00

(52) U.S. Cl. 711/108

(57) ABSTRACT

A selected word is stored in a content addressable memory (CAM) by partitioning the word into at least two segments, the segments being individually lesser in width than the CAM but in aggregate greater than the width of the CAM. A first entry in the CAM comprises a predetermined prefix and a first of the segments and a second entry in the CAM comprises a second prefix, corresponding to the address of the first segment, and the second segment. A search key is similarly partitioned. In a first search cycle a first segment of the search key prefixed by the predetermined prefix is applied to the CAM and in the event of a matching entry a second segment of the search key, prefixed by a second prefix comprising an output address word identifying the matching entry, is applied to the CAM in a second search cycle.

### FIELD OF THE INVENTION

This invention relates to search apparatus employing a CAM, i.e. a content addressable memory. The object of the invention is to permit the storage and matching of a word which is wider than the width of the CAM.

### BACKGROUND TO THE INVENTION

A content addressable memory is a memory with a searching facility which allows the comparison of a key simultaneously with all the entries in the memory and therefore in its usual form it can achieve a result, i.e. the detection of a match or partial match with the search key within one clock cycle of the search. The search result is determined by the content of the memory rather than the address of the storage location. It can be used to determine whether a given key is merely a match with a word stored in the memory but more usually it is employed to retrieve data associated with an entry. In particular, the input to a CAM may be, for example a destination address extracted from an addressed data packet which is transmitted using any of the well known protocols, such as TCP/IP. A match of the input key with a stored word yields a match address, i.e. the address of the matching entry; the match address may be used as a pointer into another memory, such as a random access memory (RAM) to retrieve data associated with the entry in the CAM. For example the associated data may be a port number, i.e. a numerical identifier of a transmit port of a switch by which the packet has been received and from which the packet should be forwarded.

Although a CAM is a rapid and versatile hardware search engine, in practice there are limitations on the size of it. For example, as explained later, the (column) lines which convey the digits of the input key to the storage cells and, usually, almost all the (row) match lines which can indicate the location of a match have to be charged and discharged each search cycle, so that the operating speed is limited and the heating effect of the CAM geometrically increases, as the CAM increases in size.

However, in modern network practice the trend is for an increase in the search width. The address width for packets conforming to Internet Protocol version six (‘Ipv6’) is 128 bits. Thus the word width is already quite large. Furthermore, a much wider width is necessary if it be desired to conduct a search on, for example a source/destination pair or to employ a CAM in a classification engine.

Accordingly various processes may require that from time to time one may need to search for words that are wider than a CAM can store in a single entry. Such a need is not well met by the provision of a CAM which is as ‘wide’ as one could possibly require: such a CAM would not perform ‘ordinary’ narrower searches efficiently. Much the same applies to the provision of two CAMs; they represent an inefficient means of performing narrower searches and require much additional external control logic and search logic.

There is therefore a need for a search engine based on a single CAM which allows a search for a word that is wider than the width of the CAM.

### SUMMARY OF THE INVENTION

The present invention is based on partitioning a word into segments, which need to be less than the width of the CAM by at least the number of digits in a coded representation of entry addresses in the CAM, so that for example if there are 2ⁿ possible entries the number of ‘address’ digits will be n. A first segment is stored with a predetermined prefix, which may be all zeroes, in any location that does not match the prefix. The prefix is not specific to the data content of the segment. A second segment is stored with a prefix comprising content corresponding to the location address in which the first segment is stored.

A search for a given word can therefore proceed by partitioning the input word similarly, and applying a first segment of the word with the aforementioned prefix to the CAM. If there is a match, the address of the matching entry is employed as or included in a prefix to the second segment.

For all words or for all words of a given type or length, the predetermined prefix would preferably be the same and is preferably all zeroes to facilitate any conflict with words that are also stored in the CAM and are occupy the full width of the CAM. However the invention does not preclude the use of different prefixes to distinguish between differently classified words or words of different lengths. Moreover both prefixes may include a respective predetermined field indicating whether the associated segment is the first or second segment.

If a bipartite partition is employed, the word thus stored can be up to (2w−2n) digits, where w is the digital width of the CAM. Thereby a word of nearly twice the width of the CAM, since w is normally much greater than n, can be stored and used to address the CAM at the cost of one extra search cycle. For example if w is 128 and n is 12 (corresponding to 2¹² locations), the 128-digit wide CAM would allow storage of words up to 232 digits.

The scheme could be extended to a triple partitioning or more, at the cost of an additional search cycle.

### BRIEF DESCRIPTION OF THE DRAWINGS

FIG. 1 is a schematic drawing showing a CAM in simplified form.

FIG. 2 is a schematic drawing of a CAM operating according to the invention.

FIG. 3 is a flow diagram illustrating a loading process.

FIG. 4 is a flow diagram illustrating a searching process.

### DETAILED DESCRIPTION

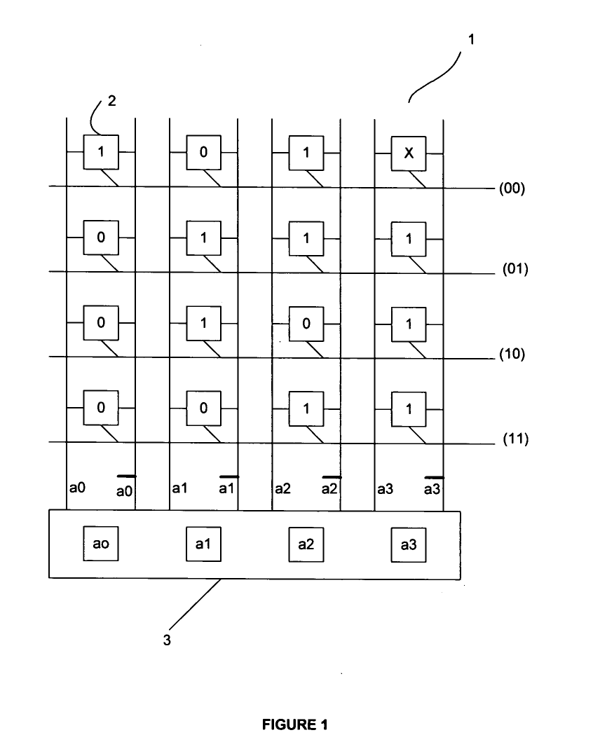

FIG. 1 of the drawings illustrates in grossly simplified form a content addressable memory 1, omitting for simplicity the circuit components within each cell and also the lines and logic required to insert entries in the memory. The illustrated CAM is only four entries ‘deep’ and each entry has a ‘width’ of only four bits. The CAM has an array of cells 2. For simplicity the means of loading the cells has been omitted but will be well understood by those skilled in the art. A word is loaded into a row of cells in parallel. For the sake of example the four words stored in the CAM are 101x, 0111, 0101 and 0011. the example is that of a ternary CAM, where in addition to storing binary digits (O or 1) a cell can be in a ‘don't care’ state, where is will detect a bit match with either binary digit. Thus the top row of the CAM can produce a match with an input word that is either 1011 or 1010. The use of ‘don't care’ digits is useful in detecting input strings rather than full addresses and is important for internet routing. The invention is applicable to binary CAMs as well as ternary CAMs.

An input word may be located in a temporary register 3. The digits of the input word are shown as a0, a1, a2 and a3. In the construction shown in FIG. 1, each column of cells (which will be compared with the respective digit in the input word) has two column lines which convey a high and low voltage to the cells. Which is which depends on the respective digit. If for example a0 is ‘1’ then the line conveying a0 will be ‘high’ and the line conveying the complement of a0 will be low.

The cells of a row are all coupled to a respective row output line. This is normally ‘high’ at the start of a cycle. If any cell in the row does not detect a match it will pull the row line low. Thus for example if the input word is 0011 all the row output lines except that marked (11).

The output lines have address, herein call match addresses. A binary representation of the address can be obtained by means of an address encoder which converts the signal indicating a match into a word which will have n binary digits where the number of row lines and therefore the number of possible entries is 2ⁿ (or between 2ⁿ⁻¹ and 2ⁿ). In the simple example the rows have addresses 00, 01, 10 and 11.

It may happen (in ternary CAMs) that two or more row lines indicate a match. It is customary then to take the lower numbered row line as indicating the correct result.

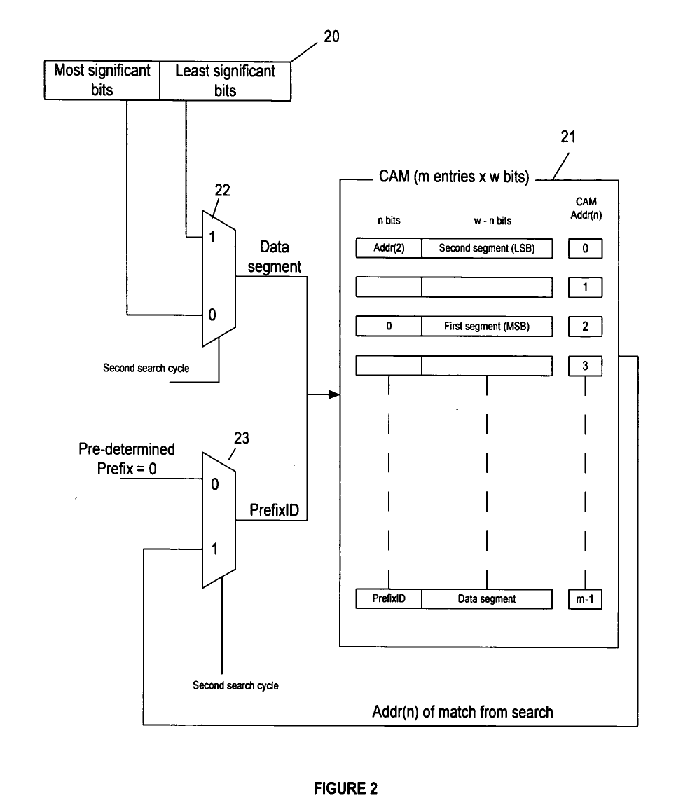

FIG. 2 illustrates schematically a CAM organized according to the invention.

The CAM 21 is shown with a multiplicity of entries. These are numbered 0 to m⁻¹. These numbers are shown for convenience against the entry, which is w digits wide. Let it be assumed that there are 4096 rows, i.e. that number of possible entries, so that m=4096, i.e. 22. For convenience let it be supposed that the width w of the CAM is 128 bits.

In the normal operation of the CAM words of up to 128 bits can be used to access the CAM in the manner discussed above. The present invention is concerned with accessing the CAM when the search word or key is wider than w, i.e. in the example wider than 128 bits. As will become apparent in the specific example that follows the search word may be up to 2×(128−12)=232 bits wide. In general, where the number of entries in the CAM is less than 2ⁿ and the width of each cam entry is w, the CAM according to the invention can accommodate (with a single partitioning of the input word as described) a search word up to 2w−2n bits. Since w is normally much greater than n, this represents nearly a doubling in the width that can be accommodated.

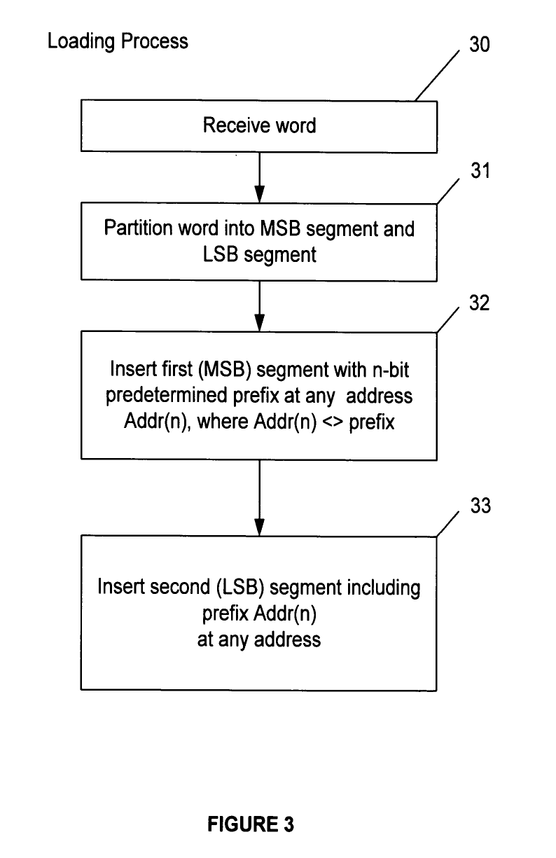

The loading process will be described with reference to FIGS. 2 and 3.

In order to enter, in the specific example, the 232-bit word into the CAM, it has to be partitioned (stage 30) into a first segment, preferably containing the most significant bits (MSBs), sand and a second segment containing the least significant bits (LSBs). In the specific example each segment contains 116 bits.

The first segment is loaded (stage 31) into the CAM at any known CAM address. The entry is loaded with a predetermined prefix consisting of n predetermined digits, where n is 12 in this example. The prefix could represent any row address in the CAM, but unless some additional measure is employed, must not match the address where the first segment is stored. Any prefix could be used, but should be used for all first segment prefixes. In the example the predetermined prefix is all zeroes (0000.0000.0000 if n is 12). The second segment, comprising preferably the least significant bits, is loaded (stage 33) into the memory at any (unused) address. The second segment is prefixed with the row address of the entry containing the first segment.

Suppose for the sake of example that the first segment is loaded at address location (2), for which the row or ‘match’ address is 0000.0000.0010. The entry at location (2) is the predetermined prefix 0000.0000.0000 followed by the 116 bits of the first segment. The second entry, shown as location (0) in FIG. 2, comprises a prefix which corresponds to the address of the entry containing the first segment, followed by the second segment. Thus this entry is in the specific example 0000.0000.0010 followed by the last 116 bits of the 232-bit data word.

Although the specific example shows a partitioning into two segments, the invention could be extended to the partitioning into more than two.

It was stated above that the prefix must not match the address where the first segment is stored. It is feasible to avoid any danger of this by adding an additional field (such as a single bit) to the prefix in order for example to distinguish between the segments. Thus each entry could be in the form <1^{st}/2^{nd} segment><AddrID><data Segment>, where, in the simplest case, <1^{st}/2^{nd} segment> is a one bit field that may be “1” to indicate the first segment and “0” to indicate the second segment.

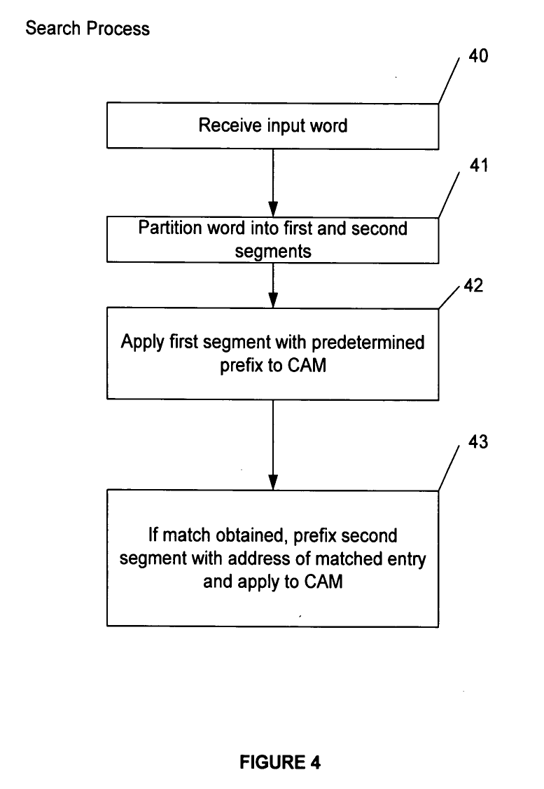

The search process is now explained with reference to FIG. 2 and the flow diagram shown in FIG. 4.

Register 20 in FIG. 2 receives the input ‘search’ word or ‘key’ (stage 40). The word is partitioned (stage 41) because the segments can be read out separately in different machine cycles. The digits can be read out in parallel through multiplexers 22 and 23. There are w-n multiplexers 22 for controlling the loading of the w-n bits in the segments and n multiplexers for controlling the loading of the n prefix bits. In the first search cycle, wherein the multiplexers are reset so pass the input signal at the terminal denoted ‘0’, the predetermined prefix, the digits of Addr(0) is applied to the lines for the cells that correspond to the prefix bits and the bits of the first segment are applied to the lines for the remaining bits. Thus in the first cycle the word Addr(0)+MSB segment is applied to the CAM (stage 42).

Since the prefix Addr(0) is predetermined and will be common to a multiplicity of CAM entries the match of the input word segment depends (as between such entries) on the content of the MSB segment. The address of the matching entry cannot be used directly to access the CAM, but in the second search cycle, wherein the multiplexers are set to pass the input at terminals ‘1’, that CAM address from the first cycle match is used as the prefix for the second segment of the input word. That address is stored in the memory as the prefix of the second segment. In this manner the match address from the first cycle is converted into part of the content of a word in the memory. Provided however that the second segment of the input word matches the second segment in the second entry, the remaining bits supplied by the first match will be automatically matched by the prefix string in the second entry.

If the data entries are in the form <1^{st}/2^{nd} segment><AddrID><data Segment> as previously indicated then the corresponding first field <1^{st}/2^{nd} segment> has to be included in the respective prefix during a search. It will be understood that the inclusion of such a field in the prefix slightly shortens by the size of that field the length of the data segment.

On the assumption that the second search cycle detects a match, the relevant row output can be used as previously described, for example to retrieve ‘associated data’ from a RAM, or otherwise.

1. A search engine, comprising:
a content addressable memory having a word width;
a register for the reception of an input word wider than said word width; and
logic for the application of the input word to the content addressable memory;
wherein said search engine:
(a) applies to said content addressable memory in a first search cycle a first data segment of said input word prefixed by a predetermined prefix; and
in the event of correspondence between said first segment of said input word prefixed by a predetermined prefix and the content of a matching entry in said content addressable memory;
(b) applies to said content addressable memory in a second search cycle a second data segment of said input word prefixed by a second prefix comprising an address word identifying said matching entry.

2. A search engine as in claim 1 wherein said first data segment comprises the most significant digits of said input word.

3. A search engine as in claim 2 wherein said second data segment comprises the least significant digits of said input word.

4. A search engine as in claim 1 wherein said predetermined prefix represents the lowest numbered address of said content addressable memory.

5. A search engine as in claim 1 wherein said first and second prefix each include a respective predetermined field indicating whether an associated data segment is the first or second data segment.

6. A search engine, comprising:
a content addressable memory having a word width;
a register for the reception of an input word wider than said word width;
a first multiplexer operative to apply in a first search cycle to a first memory segment of said content addressable memory a first data segment from said register and operative to apply in a second search cycle to said first memory segment of said content addressable memory a second data segment from said register;
a second multiplexer operative to apply in a first search cycle to a second memory segment of said content addressable memory a predetermined prefix and operative to apply in a second search cycle to said second memory segment of said content addressable memory an address output from said content addressable memory;
wherein, in the event of correspondence between said first data segment of said input word prefixed by said predetermined prefix and the content of a matching entry in said content addressable memory, said output address word identifies said matching entry.

7. A search engine as in claim 6 wherein said first data segment comprises the most significant digits of said input word.

8. A search engine as in claim 7 wherein said second data segment comprises the least significant digits of said input word.

9. A search engine as in claim 6 wherein said predetermined prefix represents the lowest numbered address of said content addressable memory.

10. A search engine as in claim 6 wherein said first and second prefix each include a respective predetermined field indicating whether an associated data segment is the first or second segment.

11. A method of storing a selected word in a content addressable memory which has a given word width, said selected word having a width greater than said word width, comprising:
(a) partitioning said selected word into at least a first data segment and a second data segment, each of the segments being lesser in width than said word width;
(b) making a first entry in said content addressable memory said first entry comprising a predetermined prefix and said first data segment, said first entry having an first address; and
(c) making a second entry in said content addressable memory, said second entry comprising a second prefix, corresponding to said first address, and said data second segment.

12. A method as in claim 10 wherein said predetermined prefix and said second prefix each include a respective predetermined field indicating whether an associated data segment is the first or second data segment.

13. A method of operating a content addressable memory having a given word width, the method comprising:
(a) partitioning a selected word into at least a first data segment and a second data segment, each of the data segments being lesser in width than said word width;
(b) making a first entry in said content addressable memory, said first entry comprising a predetermined prefix and said first data segment, said first entry having an first address;
(c) making a second entry in said content addressable memory, said second entry comprising a second prefix, corresponding to said first address, and said second data segment. (d) receiving a search key word;
(e) applying to said content addressable memory in a first search cycle a first segment of said search key word prefixed by said predetermined prefix; and
in the event of correspondence between said first segment of said input word prefixed by a predetermined prefix and the content of said first entry in said content addressable memory:
(f) applying to said content addressable memory in a second search cycle a second segment of said search key word prefixed by a second prefix comprising an address word identifying said matching entry.

14. A method as in claim 13 wherein said first data segment of said selected word comprises the most significant digits of said selected word.

15. A method as in claim 13 wherein said second data segment of said selected word comprises the least significant digits of said selected word.

16. A method as in claim 13 wherein said predetermined prefix represents the lowest numbered address of said content addressable memory.

17. A method as in claim 13 wherein said predetermined prefix and said second prefix each include a respective predetermined field indicating whether an associated data segment is the first or second data segment.
